(19) United States
(12) Patent Application Publication
(10) Pub. No.: US 2006/0166163 A1
(43) Pub. Date: Jul. 27, 2006

(54) Dental tray

(76) Inventor: Dong-Hae Ye, Daegu (KR)

Correspondence Address: MAYER, BROWN, ROWE & MAW LLP, 1909 K STREET, N.W., WASHINGTON, DC, 20006, US

(21) Appl. No.: 10/526,671

(22) PCT Filed: Oct. 19, 2002
(86) PCT No.: PCT/KR02/01959

§ 371 Date: Mar. 4, 2005

(30) Foreign Application Priority Data
Sep. 9, 2002 (KR) 2002-0054213

(51) Int. Cl. A61C 9/00

(52) U.S. Cl. 433/45; 433/41

(57) ABSTRACT

The present invention relates to an improved dental tray used in patterning a diseased tooth, and more particularly to a dental ray for implant treatment. The dental tray is characterized in that a tray main body (1) provided with a knob (101) is made of aluminum, a molding part (102) formed along the gum is opened except to a connection portion (1c), a protrusion and a bridging recess (3) are formed along the both side walls 1a and (1b) of the opened portion, a molding groove is formed by coating a connection segment (5) made of a transparent synthetic resin with a designated width and provided with a bridging groove (503) and a bridging recess (504) formed on the both connection protions (501 and 502).

### TECHNICAL FIELD

The present invention relates to an improved dental tray used in patterning a diseased tooth, and more particularly to a dental ray for implant treatment.

### BACKGROUND ART

Generally, implant treatment is treatment of that supporters are installed on the gum in order to implant a tooth and an artificial tooth is fixed to the supporters. Therefore, in the implant treatment, in order to precisely pattern the tooth, an implant zone must be exactly set centering around the supporters.

Thus, a tray in which the bottom is separated into plural segments with a constant width.

However, since the segments of the conventional developed tray are engaged with a tray main body with bolts and nuts, it is inconvenient to separate and engages the segments. Further, since the tray is made of a metal, it is impossible to drill a hole in the tray.

Moreover, since the tray made of the metal is opaque, it is impossible to drill a hole at a precise location in the tray perforate. Thus, it is inconvenient to precisely pattern the tooth using the tray.

### DISCLOSURE OF THE INVENTION

Therefore, the present invention has been made in view of the above problems, and it is an object of the present invention to engage a disposable connection segment made of a transparent synthetic resin with the bottom of a tray main body made of aluminum, thereby precisely and conveniently setting an implant zone.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective bottom view of the present invention;

FIG. 2 is a perspective top view of the present invention;

FIG. 3 is a schematic exploded top view of the present invention;

FIG. 4 is a schematic exploded bottom view of the present invention;

FIG. 5 is a cross-sectional view of the present invention;

FIG. 6 is another cross-sectional view of the present invention; and

FIG. 7 is a schematic view of the used state of the present invention.

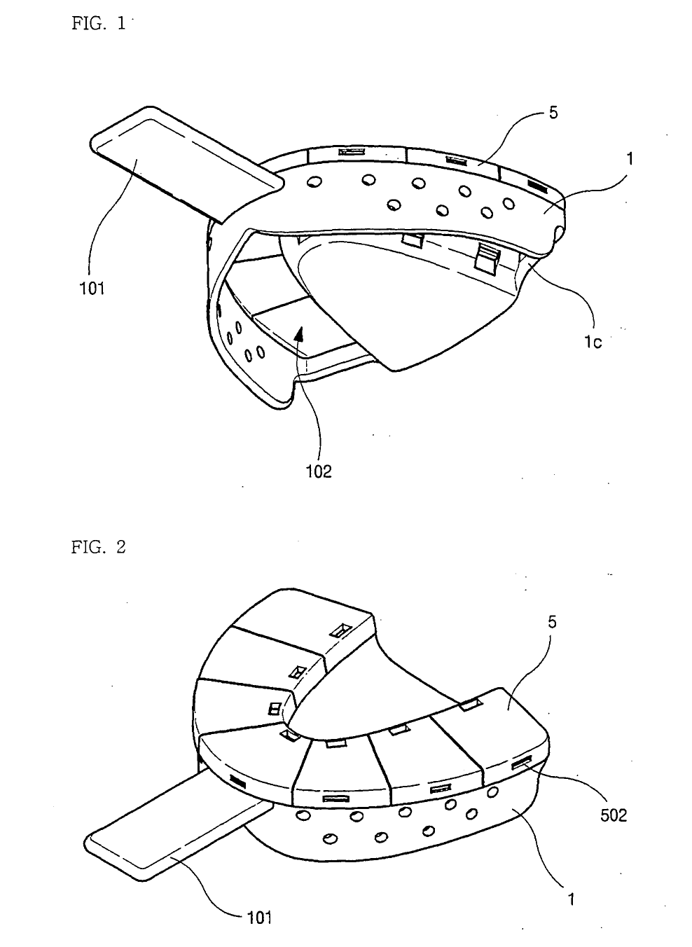

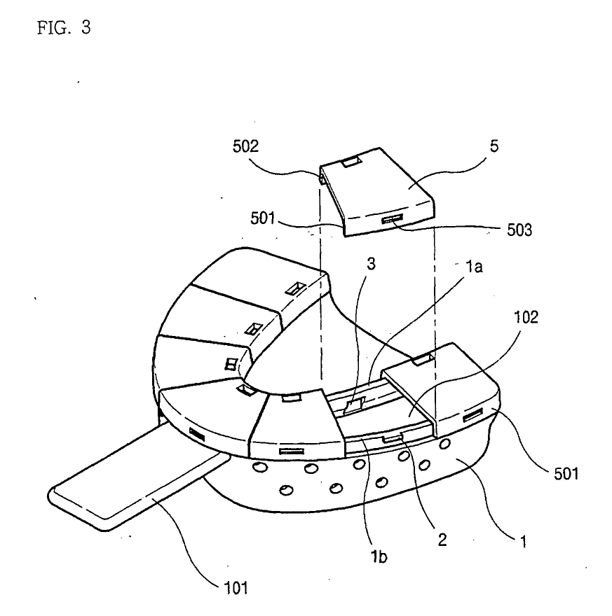

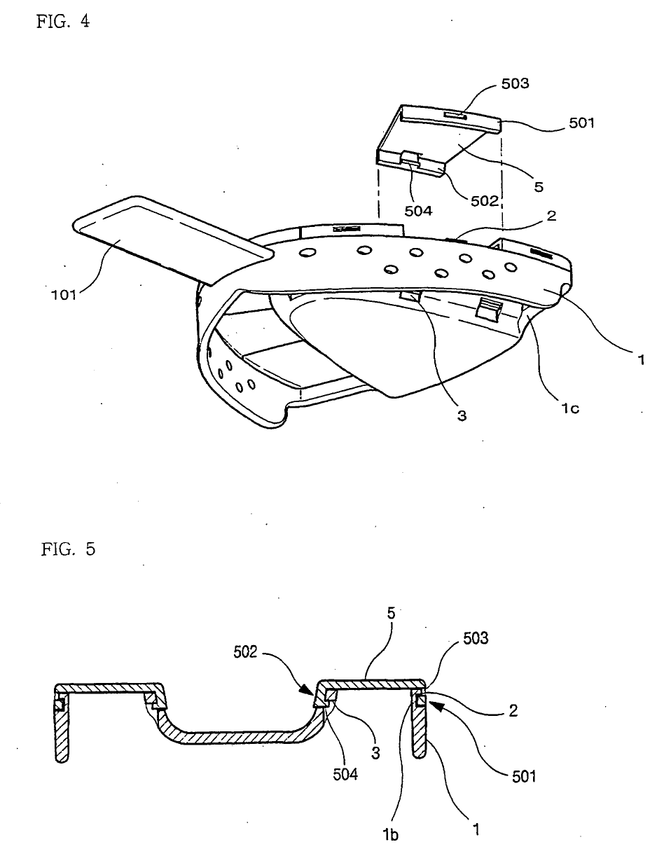

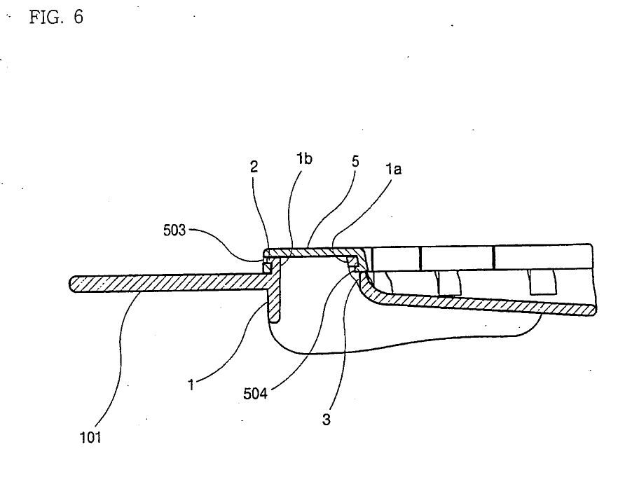

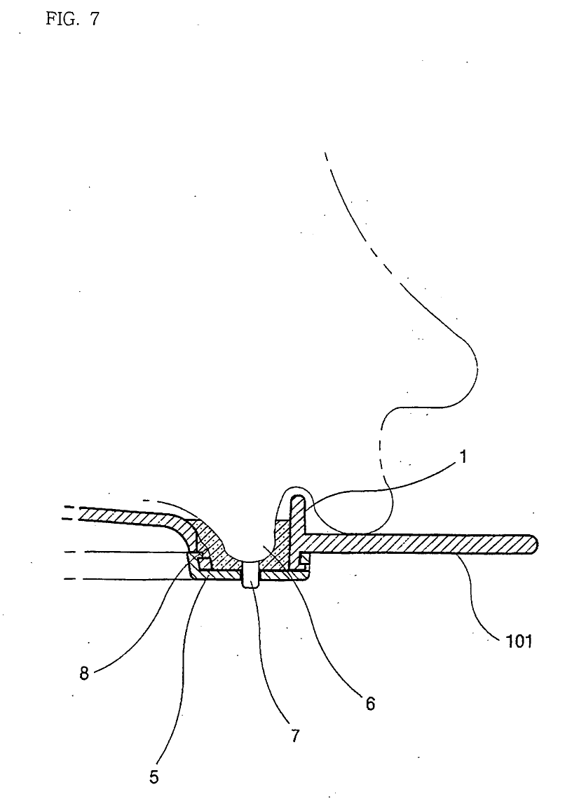

### BEST MODE FOR CARRTING OUT THE INVENTION

Hereinafter, referring to the accompanying drawings, preferred embodiments of the present invention will be described in detail.

A dental tray of the present invention is characterized that a tray main body 1 provided with a knob 101 is made of aluminum, a molding part 102 formed along the gum is opened except to a connection portion 1c, a protrusion and a bridging recess 3 are formed along the both side walls 1a and 1b of the opened portion, a molding groove is formed by coating a connection segment 5 made of a transparent synthetic resin with a designated width and provided with a bridging groove 503 and a bridging recess 504 formed on the both connection portions 501 and 502.

Herein, undescribed reference numbers 6, 7 and 8 represent the gum, a supporter 7, and a frame member 8.

In the above-described dental tray, the tray main body 1 is made of aluminum, and the connection segment 5 disposed on a molding groove 102 is made of the transparent synthetic resin and engaged with the protrusion 2 and the bridging recess 3 formed on the inner wall 1a and the outer wall 1b of the molding groove 102. Therefore, when the bridging groove 503 of the connection segment 5 is engaged with the protrusion 2 of the outer wall 1b and the birding recess 504 formed on the connection portion 502 is extended, the bridging recess 504 is engaged with the bridging recess 3 by the elasticity, thereby achieving the engagement. On the other hand, in separating, the connection segment 5 is separated from the tray main body 5 in the reverse order of the above-described process. Therefore, the present invention makes the engagement and separation of the tray main body 1 and the connection segment 5 more easily and quickly, thereby providing the convenient engagement and separation of the tray main body 1 and the connection segment 5

### INDUSTRIAL APPLICABILITY

Using the dental tray of the present invention, a dentist can correctly confirm the implant zone via the molding groove and then precisely detects the position of a fixing rod inserted into the gum, thereby precisely patterning the tooth by drill a hole on a precise location. Further, since the try main body is made of a metal with a designated strength, the tray is not deformed, thereby continuously being used by replacing only the connection segment 5 with a new one. Therefore, the present invention remarkably reduces the cost for maintaining and treating the tray.

What is claimed is:

1. A dental tray comprising:
a tray main body 1 which is provided with a knob 101, the tray main body 1 being made of aluminum, the tray main body having a molding part 102 formed along the gum which is opened except to a connection portion 1c, the tray main body 1 being formed with a protrusion 2 and a bridging recess 3 that are formed at a predetermined interval along the both side walls 1a and 1b of the opened portion;
and a connection segment 5 which is jointed on the molding part of the tray main body, the connection segment being made of a transparent synthetic resin with a designated width, the connection segment having a bridging groove 503 and a bridging recess 504 formed on the both connection portions 501 and 502,
whereby the bridging groove and the bridging recess of the connection segment is detachably joined to the protrusion and the bridging recess of the molding part of the tray main body.
